(19) United States
(12) Patent Application Publication
(10) Pub. No.: US 2025/0314416 A1
(43) Pub. Date: Oct. 9, 2025

(54) REFRIGERATING CONTAINER

(71) Applicant: Shenzhen Yanzhu Industrial Co., Ltd., Shenzhen (CN)

(72) Inventor: Sunping Lian, Shenzhen (CN)

(21) Appl. No.: 19/049,012

(22) Filed: Feb. 10, 2025

(30) Foreign Application Priority Data
Apr. 3, 2024 (CN) 202420677755.4
Apr. 3, 2024 (CN) 202420677771.3
Apr. 3, 2024 (CN) 202420687270.3

(51) Int. Cl. F25D 23/00; F25D 29/00

(52) U.S. Cl. CPC F25D 23/003; F25D 29/00; F25D 2331/806; F25D 2700/12

(57) ABSTRACT

A refrigerating container includes: a container body, having a receiving cavity for receiving liquid, wherein at least a portion of the container body is thermally conductive; a refrigeration assembly, having a refrigeration surface and a heat-conducting surface opposite to the refrigeration surface; wherein the refrigeration surface is in contact with the container body to cool the container body to cool the liquid received in the container body; and a heat dissipation assembly, being in contact with the heat conducting surface to dissipate heat from the refrigeration assembly to an outside of the container body.

### CROSS REFERENCE TO RELATED APPLICATIONS

The present application claims the benefit of Chinese Patent Application Nos. 202420677755.4, 202420677771.3 and 202420687270.3 filed on Apr. 3, 2024, the contents of which are incorporated herein by reference in their entirety.

### TECHNICAL FIELD

The present disclosure relates to the field of containers, and in particular to a refrigerating container.

### BACKGROUND

Liquid, such as alcohol, beverages, water, juices, and so on, needs to be cooled down in some cases. In the art, there are two ways to cool the liquid, such as beer, in a first way, the liquid, may be placed in a refrigerator, and the refrigerator cools the liquid. In a second way, ice cubes may be added to the liquid to cool down the liquid.

In practice, the liquid is often placed at room temperature, and the above two ways of cooling the liquid usually cannot meet user's demands for the temperature of the liquid.

### SUMMARY OF THE DISCLOSURE

The present disclosure provides a refrigerating container, including: a container body, having a receiving cavity for receiving liquid, wherein at least a portion of the container body is thermally conductive; a refrigeration assembly, having a refrigeration surface and a heat-conducting surface opposite to the refrigeration surface; wherein the refrigeration surface is in contact with the container body to cool the container body to cool the liquid received in the container body; and a heat dissipation assembly, being in contact with the heat conducting surface to dissipate heat from the refrigeration assembly to an outside of the container body.

### BRIEF DESCRIPTION OF THE DRAWINGS

In order to more clearly illustrate the technical solutions in embodiments of the present disclosure or in the art, the accompanying drawings to be used in the embodiments or in the art will be briefly introduced in the following. Obviously, the following description of the accompanying drawings shows only some of the embodiments of the present disclosure. Any ordinary skilled person in the art may obtain other drawings based on the following drawings without creative work.

FIG. 1 is a perspective view of a refrigerating container according to an embodiment of the present disclosure.

FIG. 2 is an exploded view of the refrigerating container according to an embodiment of the present disclosure.

FIG. 3 is a cross-sectional view of the refrigerating container according to an embodiment of the present disclosure.

FIG. 4 is a perspective view of the refrigerating container according to another embodiment of the present disclosure.

FIG. 5 is an exploded view of the refrigerating container according to another embodiment of the present disclosure.

FIG. 6 is a cross-sectional view of the refrigerating container according to another embodiment of the present disclosure.

FIG. 7 is a perspective view of the refrigerating container according to still another embodiment of the present disclosure.

FIG. 8 is an exploded view of the refrigerating container according to still another embodiment of the present disclosure.

FIG. 9 is a cross-sectional view of the refrigerating container according to still another embodiment of the present disclosure.

FIG. 10 is a perspective view of the refrigerating container according to still another embodiment of the present disclosure.

FIG. 11 is an exploded view of the refrigerating container according to still another embodiment of the present disclosure.

FIG. 12 is a cross-sectional view of the refrigerating container according to still another embodiment of the present disclosure.

FIG. 13 is a cross-sectional view of the refrigerating container according to still another embodiment of the present disclosure.

FIG. 14 is a perspective view of the refrigerating container according to still another embodiment of the present disclosure.

FIG. 15 is an exploded view of the refrigerating container according to still another embodiment of the present disclosure.

FIG. 16 is a cross-sectional view of the refrigerating container according to still another embodiment of the present disclosure.

### DETAILED DESCRIPTION

Unless otherwise defined, all technical and scientific terms used herein have the same meanings as being commonly understood by any ordinary skilled person in the art. The terms used herein in the specification of the present disclosure are used only for the purpose of describing specific embodiments and shall not be interpreted as limiting the present disclosure. The terms “include” and “have” and any variations thereof, used in the specification, claims and the drawings of the present disclosure are intended to cover non-exclusive embodiments. The terms “first”, “second”, and so on in the specification, claims and the accompanying drawings of the present disclosure are used to distinguish between different objects and are not used to describe a particular order.

Reference to “embodiments” herein implies that particular features, structures, or characteristics described in an embodiment may be included in at least one embodiment of the present disclosure. The presence of the phrase at various sections in the specification does not necessarily refer to the same embodiment, nor a separate or alternative embodiment that is mutually exclusive of other embodiments. It is understood by any ordinary skilled person in the art, both explicitly and implicitly, that the embodiments described herein may be combined with other embodiments.

In order to allow any ordinary skilled person in the art to better understand the embodiments of the present disclosure, technical solutions in the embodiments of the present disclosure will be clearly and completely described below by referring to the accompanying drawings.

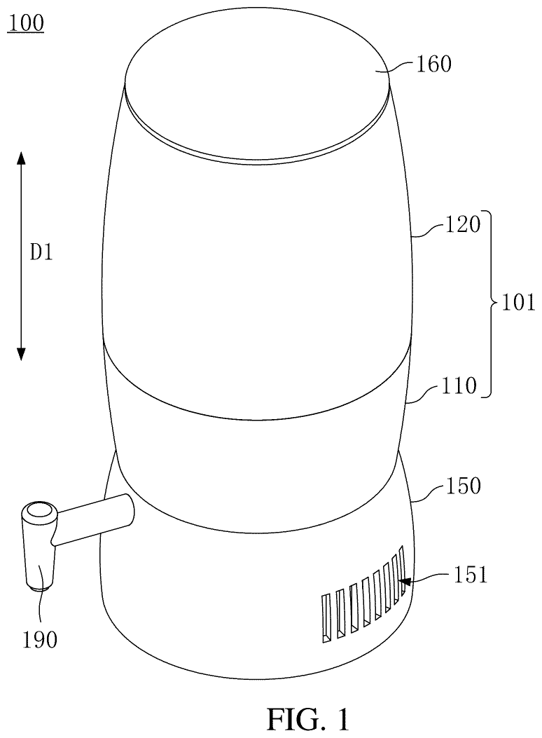

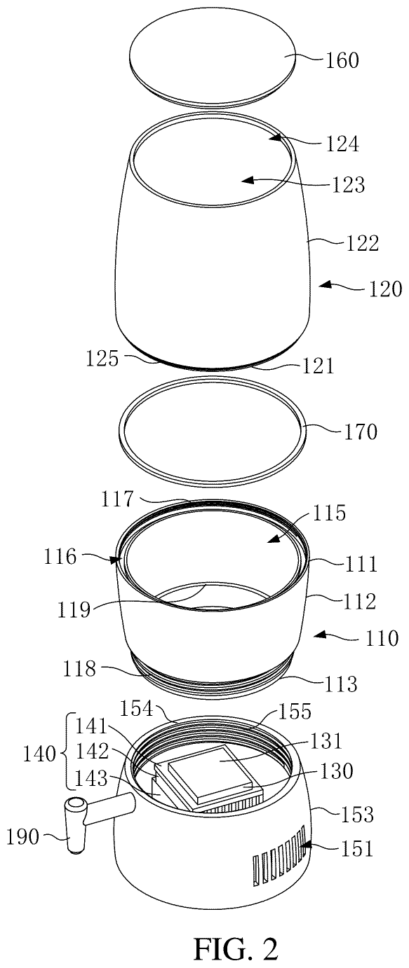

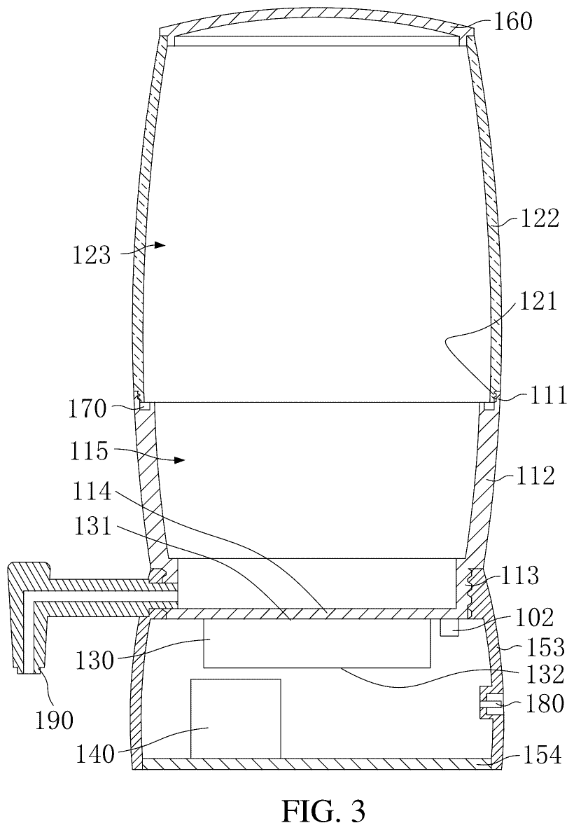

As shown in FIGS. 1 to 3, the present embodiment provides a refrigerating container 100, the refrigerating container 100 is configured to receive liquids such as alcohol, water, beverages, juices, and so on; or liquids that are mixed with certain solids, such as beverages mixed with some fruits or water mixed with ice blocks, and so on. For example, the refrigerating container 100 receives alcohol. The present embodiment is illustrated by taking the refrigerating container 100 receiving the alcohol as an example. It should be understood that the refrigerating container 100 in the present disclosure is not limited to receiving the alcohol, but may further receive other liquid that needs to be cooled.

After the beer is received in the refrigerating container 100, the refrigerating container 100 may cool the beer contained in the refrigerating container 100. In some cases, the refrigerating container 100 may continuously cool the beer contained in the refrigerating container 100. Even when the refrigerating container 100 is placed at a room temperature, such as 30 degrees Celsius, the refrigerating container 100 can still maintain the beer at a preset temperature, such as 10 degrees Celsius, for a long period of time.

The refrigerating container 100 has a height direction D1. It is to be noted that the height direction D1 of the refrigerating container 100 may be referred to as a vertical direction D1 of the refrigerating container 100.

As shown in FIGS. 1 to 3, the refrigerating container 100 includes a container body 101 that receives the liquid, such as beer. The container body 101 has an opening 124, the opening 124 is located at a top of the container body 101. The liquid, such as beer, can be poured into the container body 101 through the opening 124.

Exemplarily, the container body 101 includes a first container body 110 having a first receiving cavity 115 and a second container body 120 having a second receiving cavity 123. The first container body 101 and the second container body 120 are sealingly connected to each other, such that the first receiving cavity 115 and the second receiving cavity 123 are communicated with each other. In other words, the first container body 110 and the second container body 120 are spliced and sealed to each other to form the container body 101. The first container body 110 and the second container body 120 cooperatively receive the liquid such as beer.

It should be understood that sealed connection of the first container body 110 and the second container body 120 prevents the liquid from leaking through a location where the first container body 110 and the second container body 120 are connected to each other.

Exemplarily, the first container body 110 and the second container body 120 are arranged along the height direction D1 of the refrigerating container 100. Alternatively, the first container body 110 and the second container body 120 are spliced and sealed to each other along the vertical direction D1 of the refrigerating container 100 to form the container body 101. Exemplarily, the second container body 120 is connected to a top of the first container body 110. The opening 124 of the container body 101 is located at a top of the second container body 120. It is noted that a direction in which the first container body 110 and the second container body 120 are spliced to each other is not limited to the vertical direction D1 of the refrigerating container 100. For example, the first container body 110 and the second container body 120 may be spliced and sealed to each other along a circumferential direction of the refrigerating container to form the container body 101.

Exemplarily, sealing connection of the first container body 110 and the second container body 120 may be achieved by arranging a seal ring 170 connected between the first container body 110 and the second container body 120. It should be understood that the sealing connection of the first container body 110 and the second container body 120 is not limited to arranging the seal ring 170. One of the first container body 110 and the second container body 120 defines a sealing groove 116, the seal ring 170 is received in the sealing groove 116. The other of the first container body 110 and the second container body 120 abuts against the seal ring 170. In this way, the first container body 110 and the second container body 120 are sealed to each other.

Exemplarily, the sealing groove 116 is defined in the first container body 110. it should be understood that the sealing groove 116 may alternatively be defined in the second container body 120.

Exemplarily, the seal ring 170 can be deformed to some extent. When the seal ring 170 is compressed by an external force such as the second container body 120, the seal ring 170 may be deformed to a small extent, a sealing effect of at connection between the first container body 110 and the second container body 120 is improved.

It should be noted that a container that receives liquids, such as beer, usually has a small thickness, defining the sealing groove in the thin container may lead to damage to the container or lead to instable connection between the containers.

It should also be noted that the container that receives the liquid, such as beer, is usually made of glass. Defining the sealing groove in the glass, especially in the glass with having the small thickness lead to damage to the container or lead to instable connection between the containers.

In order to increase structural strength of the first container body 110 and the second container body 120 and improve stability of connection between the first container body 110 and the second container body 120, the first container body 110 in the present embodiment is made of metal, such as stainless steel. A thickness of at least part of the first container body 110 is greater than a thickness of the second container body 120. Exemplarily, a thickness of a portion of the first container body 110 that defines the sealing groove 116 is at least greater than the thickness of the second container body 120. During processing in practice, since the sealing groove 116 is defined in the first container body 110 that is made of metal and has the thickness that is greater than the thickness of the second container body 120, the structural strength of both the first container body 110 and the second container body 120 are maintained, connection stability and sealing performance of the first container body 110 and the second container body 120 are maintained.

Specifically, the sealing groove 116 is defined at an end of the first container body 110 near the second container body 120, and an end of the second container body 120 near the first container body 110 abuts against the seal ring 17.

Exemplarily, the first container body 110 includes a first side wall 112 and a first connection portion 111 connected to the first side wall 112. The first connection portion 111 is connected to a top of the first side wall 112. For example, the first side wall 112 and the first connection portion 111 are integrally formed as a one-piece structure. The second container body 120 includes a second side wall 122 and a second connection portion 121 connected to the second side wall 122. The first connection portion 111 is connected to the second connection portion 121, and the first connection portion 111 wraps around the second connection portion 121. In this way, the connection stability and the sealing performance between the first container body 110 and the second container body 120 are further improved.

Exemplarily, a thickness of the first side wall 112 is greater than a thickness of the second side wall 122. The sealing groove 116 is defined in an end of the first side wall 112 near the first connection portion 111. The first connection portion 111 is disposed at an outer side of the sealing groove 116. The second connection portion 121 abuts against the seal ring 170 received in the sealing groove 116.

Exemplarily, an end of the first connection portion 111 away from the first side wall 112 abuts against the second side wall 122, and an outer surface of the first connection portion 111 is smoothly transited to an outer surface of the second side wall 122. Exemplarily, the outer surface of the first connection portion 111 and the outer surface of the second sidewall 122 are aligned with each other. Alternatively, the outer surface of the first connection portion 111 and the outer surface of the second sidewall 122 are coplanar at a location where the outer surface of the first connection portion 111 and the outer surface of the second sidewall 122 are connected to each other.

Exemplarily, the first connection portion 111 is threaded with the second connection portion 121. For example, a first thread 117 is arranged on an inner surface of the first connection portion 111, and a second thread 125 is arranged on an outer surface of the second connection portion 121, the first thread 117 and the second thread 125 are connected to each other.

Exemplarily, the thickness of the first connection portion 111 is less than the thickness of the first side wall 112 and the thickness of the second side wall 122. The thickness of the second connection portion 121 is less than the thickness of the first side wall 112.

The second container body 120 is transparent. For example, the second container body 120 is made of glass or plastic.

Exemplarily, the first container body 101 is thermal conductive, alternatively, the first container body 101 has thermal conductivity. For example, the first container body 101 is made of metal.

As shown in FIGS. 1 to 3, the refrigerating container 100 further includes a refrigeration assembly 130 and a heat dissipation assembly 140. The refrigeration assembly 130 has a refrigeration surface 131 and a heat conduction surface 132 opposite to the refrigeration surface 131. The refrigeration surface 131 is in contact with the first container body 110, and the heat dissipation assembly 140 is in contact with the heat conduction surface 132. The refrigeration assembly 130 can conduct heat of the liquid, such as beer, received in the first receiving cavity 115 to the heat dissipation assembly 140 through the first container body 110. The heat dissipation assembly 140 dissipates the heat from the refrigeration assembly 130 to an outside of the refrigerating container 100. For example, the refrigeration assembly 130, when being supplied with power, conducts heat from the liquid received in the first receiving cavity 115 through the first container body 110 to the heat dissipation assembly 140, and the heat dissipation assembly 140, when being supplied with power, dissipates heat from the refrigeration assembly 130 to the outside of the refrigerating container 100.

Exemplarily, both the refrigeration assembly 130 and the heat dissipation assembly 140 can be supplied with power simultaneously. It is noted that in some cases, the refrigeration assembly 130 and the heat dissipation assembly 140 may be supplied with power at different time points. For example, the refrigeration assembly 130 is supplied with power firstly, and the heat dissipation assembly 140 is supplied with power at a later time point. A time interval between the time point when the refrigeration assembly 130 is supplied with power and the time point when the heat dissipation assembly 140 is supplied with power is less than a predetermined value, such as 1 second, 2 seconds, 3 seconds, and so on.

Exemplarily, the heat dissipation assembly 140 may include one or more heat dissipation sheets. Exemplarily, the heat dissipation assembly 140 includes one first heat dissipation sheet 141 and a plurality of second heat dissipation sheets 142. The plurality of second heat dissipation sheets 142 are spaced apart from each other and are connected to a side of the first heat dissipation sheet 141, and the other side of the first heat dissipation sheet 141 is attached to the heat conduction surface 132. That is, the first heat dissipation sheet 141 is disposed between the refrigeration assembly 130 and the plurality of second heat dissipation sheets 142.

Exemplarily, the heat dissipation assembly 140 includes one or more fans 143, and in an example, the heat dissipation assembly 140 includes one first heat dissipation sheet 141, a plurality of second heat dissipation sheets 142, and one fan 143. The fan 143 is disposed below the plurality of second heat dissipation sheets 142, and that is, the plurality of second heat dissipation sheets 142 are disposed between the fan 143 and the first heat dissipation sheet 141, and the fan 143 accelerates heat dissipation.

The refrigerating container 100 further includes a power connector 180. The power connector 180 is connected to the heat dissipation assembly 140 and the refrigeration assembly 130. For example, the power connector 180 is connected to the heat dissipation assembly 140 and the refrigeration assembly 130 via a wire. The power connector 180 may be connected to the utility power via a charging cable to supply power to the refrigeration assembly 130 and the heat dissipation assembly 140. In this way, the refrigeration assembly 130 and the heat dissipation assembly 140 can be supplied with power to operate.

In some embodiments, the refrigerating container 100 further includes a power source such as a battery. The battery is connected to the heat dissipation assembly 140 and the refrigeration assembly 130. For example, the battery is connected to the heat dissipation assembly 140 and the refrigeration assembly 130 via a wire. The battery directly supplies power to the power connector 180 and the heat dissipation assembly 140. The battery may be a rechargeable battery, for example, the battery is connected to the power connector 180. In some embodiments, the battery may be a disposable battery.

In the present embodiment, the refrigeration assembly 130, the heat dissipation assembly 140, and the power connector 180 can all be arranged inside a mounting housing 150. For example, the mounting housing may be a one-piece housing or a housing assembly formed by a plurality of housing structures. It should be understood that the mounting housing 150 serves as a carrier for the refrigeration assembly 130, the heat dissipation assembly 140, and the power connector 180; and is also connected to the container body 101. The mounting housing 150 is located at a top or a bottom of the container body 101. When the mounting housing 150 is located at the bottom of the container body 101, the mounting housing 150 can support the container body 101. Exemplarily, the mounting housing 150 is connected to the first container body 110, and the second container body 120, the first container body 110, and the mounting housing 150 are disposed sequentially in the height direction D1 of the refrigerating container 100.

Exemplarily, the first container body 110 further includes a bottom wall 114 and a third connection portion 113, the third connection portion 113 is connected to a peripheral edge of the bottom wall 114. An end of the third connection portion 113 away from the bottom wall 114 is connected to an end of the first side wall 112 away from the second container body 120.

Exemplarily, the third connection portion 113 and the first side wall 112 are misaligned with each other while being connected to each other. The third connection portion 113 and the first side wall 112 cooperatively form a step 119 inside the first container body 110.

Exemplarily, the third connection portion 113 is connected to the mounting housing 150. Exemplarily, the third connection portion 113 is threaded to the mounting housing 150. In an example, a third thread 118 is arranged on an outer surface of the third connection portion 113, and a fourth thread 155 is arranged on the mounting housing 150. The third thread 118 is connected to the fourth thread 155.

Exemplarily, the mounting housing 150 wraps around the third connection portion 113. The mounting housing 151 abuts against the end of the first side wall 112 away from the second container body 120. An outer surface of the mounting housing 150 is smoothly transitted to the outer surface of the first side wall 112. For example, the outer surface of the mounting housing 150 and the outer surface of the first side wall 112 are aligned with each other. Alternatively, the outer surface of the mounting housing 150 and the outer surface of the first container body 110 are coplanar at location where the mounting housing 150 and the first container body 110 are connected to each other.

Exemplarily, a thickness of the bottom wall 114 is less than a thickness of the first side wall 112.

Exemplarily, a thickness of the third connection portion 113 is less than or equal to the thickness of the first side wall 112. Exemplarily, the third connection portion 113 and the first side wall 112 are misaligned with each other.

The mounting housing 150 defines a plurality of heat dissipation holes 151, and the heat dissipation assembly 140 dissipates the heat from the refrigeration assembly 130, through the plurality of heat dissipation holes 151, to the outside of the mounting housing 150.

The mounting housing 150 includes a bottom wall 152 and a third side wall 153. The bottom wall 152 is connected to the third side wall 153. The bottom wall 152 and the third side wall 153 are configured as an integral and one-piece structure. Exemplarily, the plurality of heat dissipation holes 151 are spaced apart from each other are defined in the third side wall 153. For example, the plurality of heat dissipation holes 151 are distributed surrounding the third side wall 153 to form one loop. The plurality of heat dissipation holes 151 surrounds the heat dissipation assembly 140. Exemplarily, the charging connector 180 is mounted on the third sidewall 153.

In other embodiments, the bottom wall 152 further defines one or more heat dissipation holes.

It should be understood that, while maintaining structural strength of the mounting housing 150, the number and sizes of the heat dissipation holes 151 may be determined according to actual needs, and are not limited by the present disclosure.

The mounting housing 150 further includes a fourth connection portion 154. The fourth connection portion 154 is connected to the third side wall 153. The fourth connection portion 154 is disposed at an end of the third side wall 153 away from the bottom wall 152. The fourth thread 155 is arranged on an inner surface of the fourth connection portion 154. The fourth connection portion 154 is connected to the third connection portion 113. The fourth connection portion 154 wraps around or surrounds the third connection portion 113. The fourth connection portion 154 abuts against the first side wall 112, and an outer surface of the fourth connection portion 154 smoothly transits to an outer surface of the first side wall 112.

Exemplarily, the thickness of the fourth connection portion 154 gradually increases from the end away from the bottom wall 152 to the other end thereof to improve connection stability between the mounting housing 150 and the first container body 110.

In other embodiments, the mounting housing 150 further includes a limiting platform. The limiting platform is connected to an inner surface of the third side wall 153 and is disposed below the fourth thread 155. The limiting platform is configured to limit the bottom wall 114. For example, the bottom wall 114 is attached to the limiting platform. Exemplarily, the mounting housing 150 further includes a refrigeration hole defined in the limiting platform. At least a portion of the refrigeration surface 131 of the refrigeration assembly 130 is exposed from the refrigeration hole to be in contact with the bottom wall 114.

Exemplarily, a portion of the refrigeration assembly 130 is received in the refrigeration hole. The refrigeration surface 131 is aligned with a surface of the limiting platform. The bottom wall 114 is attached to the refrigeration surface 131 and the limiting platform.

In some embodiments, the refrigeration surface 131 protrudes from the limiting platform. Accordingly, the bottom wall 114, while being in contact with the refrigeration surface 131, defines a recess to receive the refrigeration surface 131.

In some embodiments, the refrigeration surface 131 is received in the refrigeration hole, or the refrigeration surface 131 is located below the limiting platform. A protruding portion is arranged below the bottom wall 114 and is received in the refrigeration hole to be in contact with the refrigeration surface 131.

As shown in FIGS. 1 to 3, the refrigerating container 100 further includes an outlet control head 190. The outlet control head 190 is mounted on the mounting housing 150. The outlet control head 190 is communicated with the first receiving cavity 115 of the first container body 110. A user may manipulate the outlet control head 190 to take the liquid received in the first container body 110.

As shown in FIGS. 1 to 3, the refrigerating container 100 further includes a top cover 160. The top cover 160 is detachably mounted on the top of the second container body 120. The top cover 160 covers the opening 124 when being mounted on the second container body 120.

It should be noted that arrangement between the second container body 120 and the first container body 110 in the present embodiment is not limited to the height direction D1 of the refrigerating container 100, the second container body 120 and the first container body 110 may be arranged in other directions, such as in a lateral direction, which is perpendicular to the height direction D1 of the refrigerating container 100.

In some embodiments, in order to further increase the sealing performance of the connection between the first container body 110 and the second container body 120, a sealing sleeve may be arranged on the outer surface of the first container body 110 and the second container body 120.

As shown in FIGS. 1 to 3, the refrigerating container 100 further includes a detection member 102 configured to detect information about the beer received in the container body 101, such as temperatures, the amount of beer, and so on.

Exemplarily, the detection member 102 detects how much liquid, such as beer, is received in the container body 101. When the detection member 102 detects that the amount of beer received in the container body 101 is decreased to reach a predetermined amount, the detection member 102 sends a control signal of insufficient beer in order to control the refrigeration assembly 130 and the heat dissipation assembly 140 to stop operating or to operate at a lower operating power. Further, the refrigerating container 100 further includes a prompter. The prompter, when receiving the control signal of insufficient beer emitted from the detection member 102, is configured to provide a prompt message, such as emitting a sound, to inform the user to add beer.

Exemplarily, the detection member 102 detects a temperature of the liquid in the container body 101. When the detection member 102 detects that the temperature of the beer in the container body 101 has reached a predetermined temperature, the detection member 102 sends a control signal of beer reaching the predetermined temperature in order to control the refrigeration assembly 130 and the heat dissipation assembly 140 to stop operating or to operate at a lower operating power. When the detection member 102 detects that the temperature of the beer in the container body 101 does not reach the predetermined temperature, the detection member 102 sends a control signal of the beer not reaching the predetermined temperature to control the refrigeration assembly 130 and the heat dissipation assembly 140 to operate.

The detection member 102 may include one or more sensor sensors, such as a temperature sensor.

Other configurations of the container body of the refrigerating container are exemplarily described below by referring to other accompanying drawings.

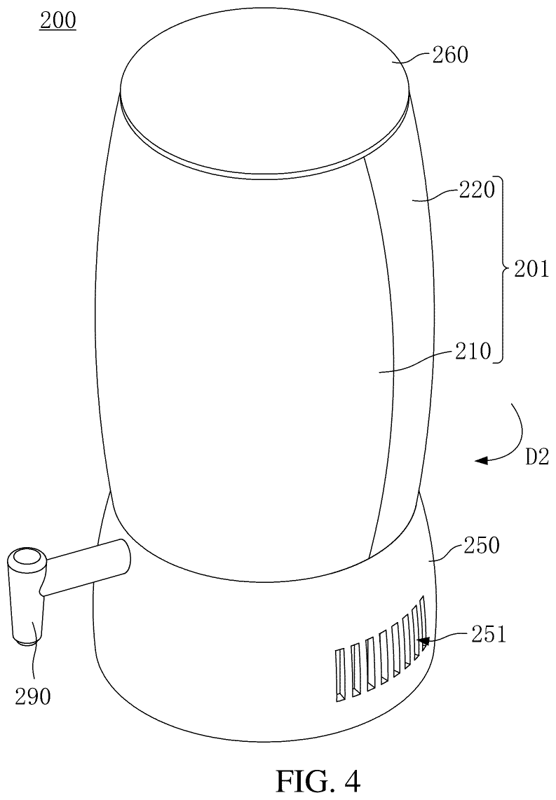

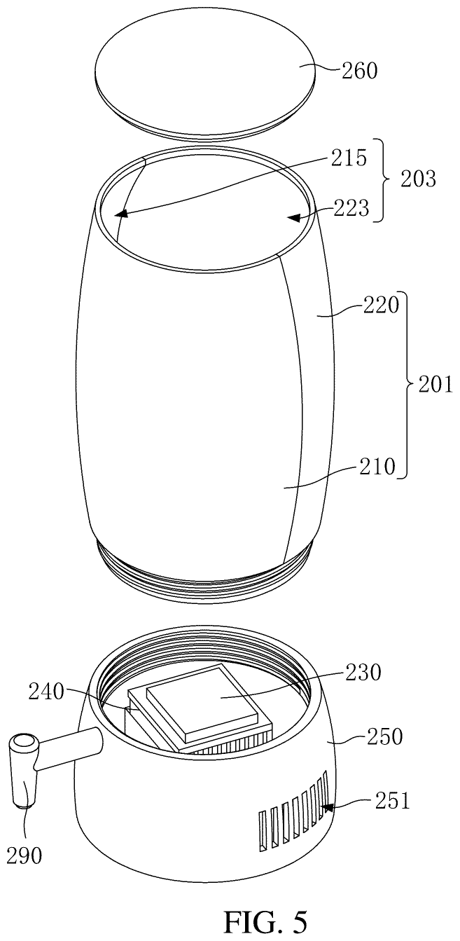

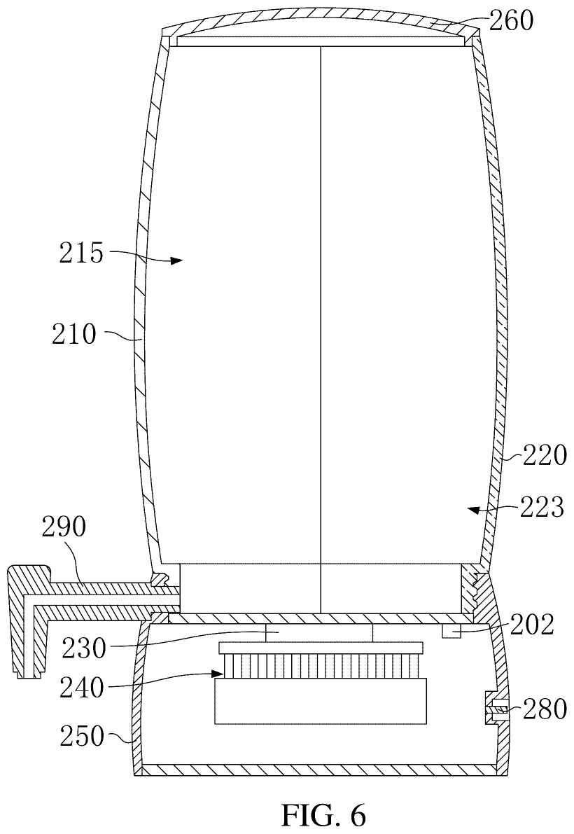

As shown in FIGS. 4 to 6, another refrigerating container 200 is provided, the first container body 210 and the second container body 220 of the refrigerating container 200 are spliced and sealed to each other along the circumferential direction D2 of the refrigerating container 200 to form the container body 201. The first container body 210 is thermally conductive and is made of metal. The second container body 220 is transparent and is made of transparent glass, transparent plastic, and so on. Splicing and sealing of the first container body 210 and the second container body 220 may be referred to that of the first container body 101 and the second container body 120, and will not be repeated herein. It is noted that the first container body 210 and the second container body 220 may alternatively be connected to each other for form the container body 201.

Exemplarily, the first container body 210 is in contact with, such as attached to, the refrigeration surface of the refrigeration assembly 230. The heat conduction surface of the refrigeration assembly 230 is in contact with the heat dissipation assembly 240. In this way, the refrigeration assembly 230, when being supplied with power, conducts heat from the liquid, such as beer, in the first container body 210 to the heat dissipation assembly 240, and the heat dissipation assembly 240, when being supplied with power, dissipates heat from the refrigeration assembly 230 to the outside of the mounting housing 250 through the heat dissipation holes 251. The heat dissipation assembly 240 and the refrigeration assembly 230 are mounted inside the mounting housing 250. Structures of the mounting housing 250, the heat dissipation assembly 240, and the refrigeration assembly 230 of the present embodiment may be referred to those in the above embodiment, and will not be repeated herein.

Exemplarily, for the refrigerating container 200 in the present embodiment, the first container body 210 and the second container body 220 are both connected to the mounting housing 250, such as by threading. Specific structures of the first container body 210 and the second container body 220 connected with the mounting housing 250 may be referred to those in the above embodiment, and will not be repeated herein.

Other components in the refrigerating container 200, such as the power connector 280, the outlet control head 290, the top cover 260, and the detection member 202, may be referred to those in the above embodiment and will not be repeated herein.

It is to be noted that, in the present embodiment, the first container body 210 and the second container body 220 are sealed and spliced to each other along the circumferential direction D2 of the refrigerating container 200. The first container body 210 defines a first receiving cavity 215, and the second container body 220 defines a second receiving cavity 223. The first receiving cavity 215 and the second receiving cavity 223 cooperatively form the receiving cavity 203. When the first receiving cavity 215 and the second receiving cavity 223 cooperatively receive the liquid, the liquid received in both the second receiving cavity 223 is located closer to the refrigeration assembly 230, compared to the liquid being received in the second receiving cavity 123. In this way, the liquid received in the refrigerating container 200 is more uniformly cooled and is cool more quickly than the liquid received in the refrigerating container 100 is.

Furthermore, the user may view a state of the liquid received in the container body 101 by viewing through the transparent second container body 120, and the user may view the state of the liquid received in the container body 201 by viewing through the transparent second container body 220. In comparison, the user may view the state of the liquid received in only the second container body 120, whereas the user may view the state of the liquid received in both the first container body 210 and the second container body 220 by viewing through the second container body 220.

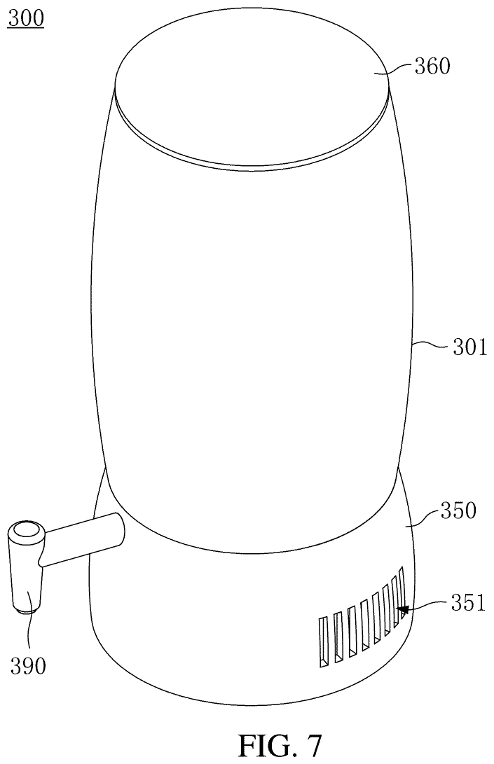

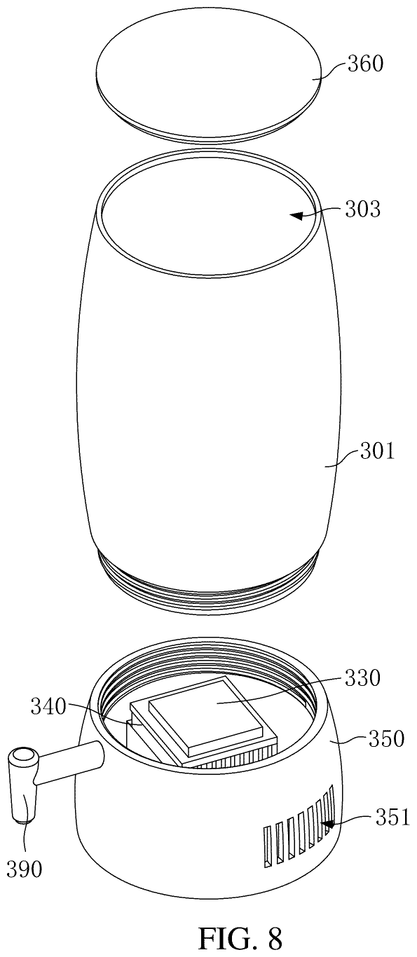

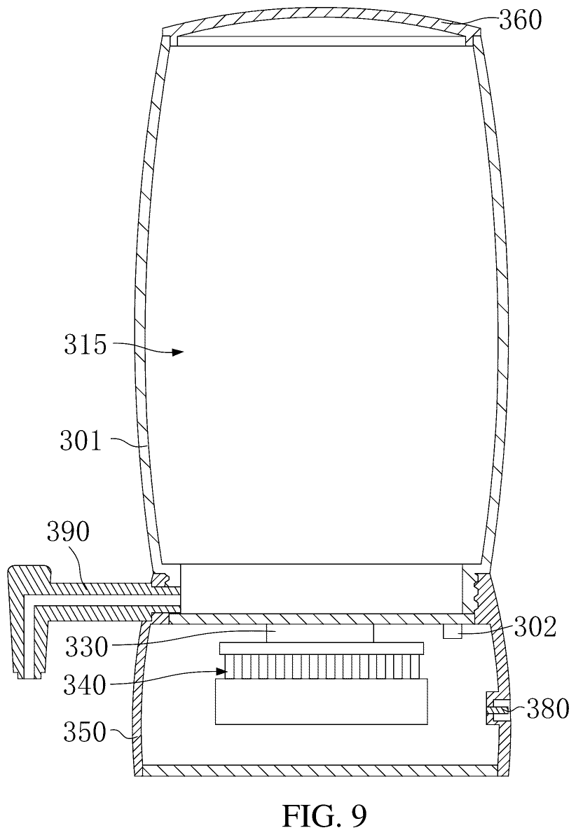

As shown in FIGS. 7 to 9, another refrigerating container 300 is provided. The container body 301 of the refrigerating container 300 is a one-piece structure and is thermally conductive. For example, the container body 301 is made of metal.

Exemplarily, the container body 301 is in contact with, such as attached to, the refrigeration surface of the refrigeration assembly 330. The heat conduction surface of the refrigeration assembly 330 is in contact with, such as attached to, the heat dissipation assembly 340. In this way, the refrigeration assembly 330, when being supplied with power, conducts heat from the liquid in the container body 301 to the heat dissipation assembly 340; and the heat dissipation assembly 340, when being supplied with power, dissipates heat from the refrigeration assembly 330 to the outside of the mounting housing 350 through the heat dissipation holes 351. The heat dissipation assembly 340 and the refrigeration assembly 330 are mounted inside the mounting housing 350. Structures of the mounting housing 350, the heat dissipation assembly 340, the refrigeration assembly 330, and the detection member 302 in the present embodiment may be referred to those in the above embodiment and will not be repeated herein.

The container body 301 is connected to, such as threaded to, the mounting housing 350. Connection between the container body 301 and the mounting housing 350 may be referred to the connection between the first container body 101 and the mounting housing 150, and will not be repeated herein.

Other components in the refrigerating container 200 such as the power connector 280, the outlet control head 290, and the top cover 260 may be referred to those in the above embodiment and will not be repeated herein.

It should be noted that the entire container body 301 of the present embodiment is made of metal, for example, the container body 301 may be a one-piece and integral structure. In practice, the container body 301 has thermal conductivity, compared to the refrigerating container 100 and the refrigerating container 200, the container body 301 provides better refrigeration effect on the liquid contained in the receiving cavity 303. However, in practice, since the container body 301 is made of metal, which is not transparent, the user may not view the state of the liquid contained in the receiving cavity 303 of the container body 301.

In order to facilitate the user to view the state of the liquid contained in the receiving cavity 303 of the container body 301, a hole may be defined in the container body 301, and a transparent member may be embedded in the hole. Detailed structure may be illustrated in the following.

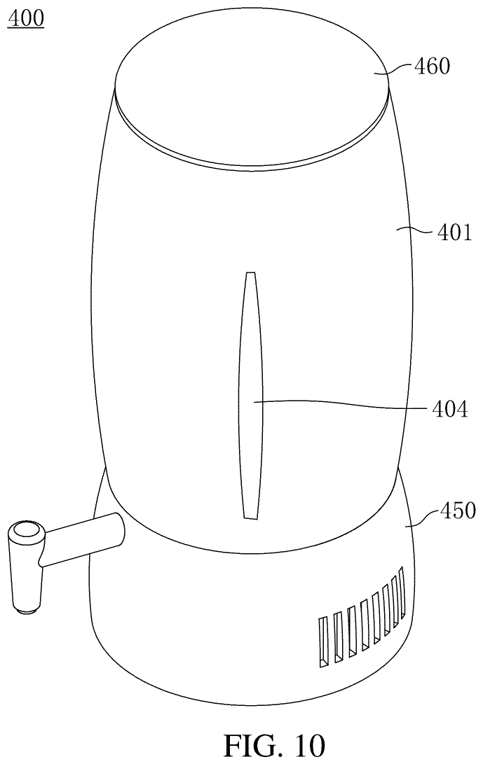

As shown in FIG. 10, a refrigerating container 400 is shown in FIG. 10, the container body 401 of the refrigerating container 400 is embedded with a transparent member 404. The transparent member 404 is elongated and extending in the height direction/vertical direction of the refrigerating container 300. Exemplarily, the transparent member 404 is disposed between the top cover 460 and the mounting housing 450. The transparent member 404 is spaced apart from the top cover 460 and the mounting housing 450, i.e., the transparent member 404 is not connected to either the top cover 460 or the mounting housing 450.

Exemplarily, a minimum distance between the transparent member 404 and the top cover 460 is greater than a minimum distance between the transparent member 404 and the mounting housing 450.

It should be understood that, in the present embodiment, the transparent member 404 is transparent, for example, the transparent member 404 is made of transparent plastic or transparent glass. The container body 401 has thermal conductivity, such as being made of metal, facilitating the user to view the state of the liquid contained in the container body 401 through the transparent member 404.

It should also be understood that after the transparent member 404 is embedded in the container body 401, connection position where the transparent member 404 and the container body 401 are connected to each other is sealed.

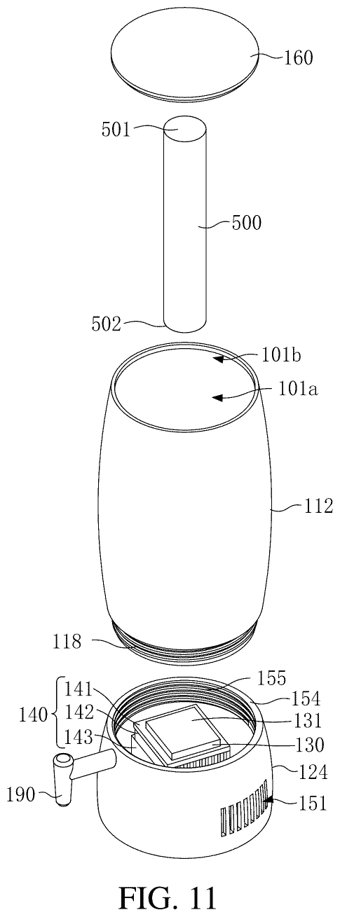

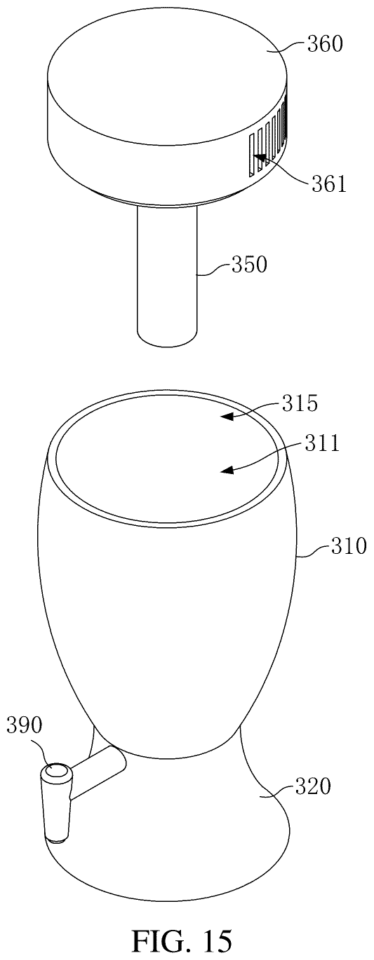

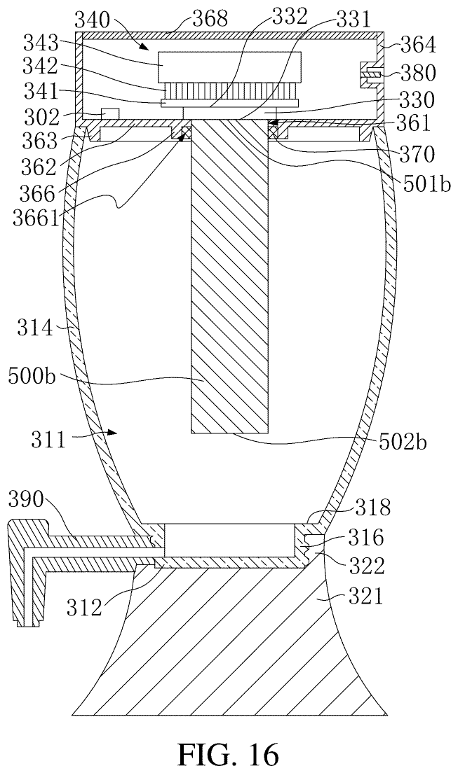

As shown in FIGS. 11 to 16, the present embodiment further provides a refrigerating container 100 including the container body 101. The container body 101 has a receiving cavity 101a. The refrigerating container 100 further includes a heat-conducting component 500. The heat-conducting component 500 is mounted in the container body 101 and/or the mounting housing 150, i.e., the heat-conducting component 500 may be mounted in the container body 101; or mounted in the mounting housing 150; or mounted in both the container body 101 and the mounting housing 150.

The heat-conducting component 500 has thermal conductivity, i.e., the heat-conducting component 500 can conduct heat. For example, the heat-conducting component 500 is made of metal

Exemplarily, the heat-conducting component 500 may be a solid structure, for example, the heat-conducting component 500 may be a cylindrical structure. In other embodiments, the heat-conducting component 500 may be a circular platform structure, a conical structure. It should be understood that the heat-conducting component 500 may also be columnar structures. The present disclosure does not limit a shape of the heat-conducting component 500.

In other embodiments, the heat-conducting component 500 may not be solid. For example, in order to save material, the heat-conducting component 500 has a cavity therein. To be noted that, in order to prevent the liquid in the receiving cavity 111 from entering the cavity inside the heat-conducting component 500, the cavity of the heat-conducting component 500 is sealed.

The heat-conducting component 500 is at least partially disposed in the receiving cavity 101a. The heat-conducting component 500 at least passes through the container body 101 to enable a bottom end 502 of the heat-conducting component 500 to be in contact with the refrigeration surface 131. In other words, the heat-conducting component 500 at least passes through the container body 101 to abut against the refrigeration surface 131. In this way, the refrigeration assembly 130 passes heat of the liquid received in the receiving cavity 101a through the heat-conducting component 500 to the heat dissipation assembly 140. The heat dissipation assembly 140 dissipates the heat from the refrigeration assembly 130 to the outside of the container. In an example, the refrigeration assembly 130, when being supplied with power, conducts heat of the liquid contained in the receiving cavity 101a to the heat dissipation assembly via the heat-conducting component 500.

A top end 501 of the heat-conducting component 500 is located near the opening 101b of the container body 101.

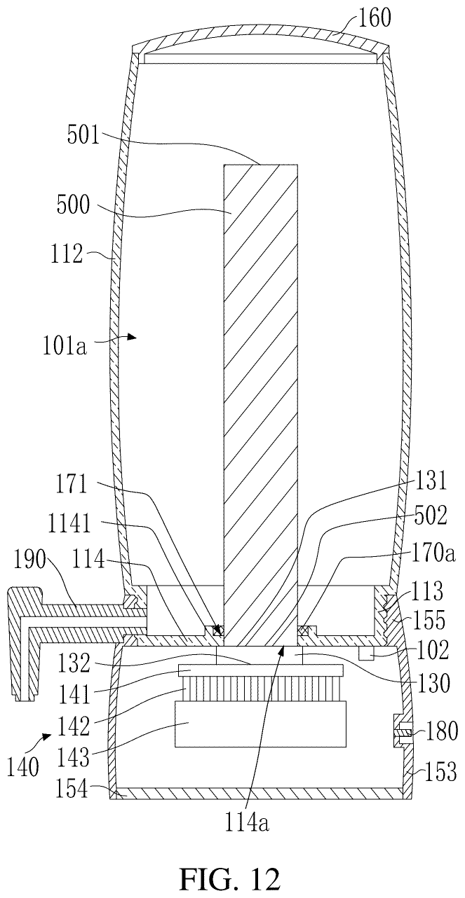

Exemplarily, the heat-conducting component 500 is sealingly connected to the container body 101 and/or the mounting housing 150, i.e., the heat-conducting component 500 is sealingly connected to the container body 101, or the heat-conducting member 500 is sealingly connected to the mounting housing 150, or the heat-conducting member 500 is sealingly connected to both the container body 101 and the mounting housing 150. As shown in FIGS. 11 and 12, in an example, the heat-conducting component 500 is sealingly connected to the container body 101, the sealing connection between the heat-conducting component 500 and the mounting housing 150 will be illustrated below.

As shown in FIGS. 11 and 12, the container body 101 includes a first bottom wall 114 and a first side wall 112 connected to the first bottom wall 114. For example, the first bottom wall 114 and the first side wall 112 are configured as a one-piece and integral structure. The first bottom wall 114 is connected to a bottom of the first side wall 112. The heat-conducting component 500 passes through at least the first bottom wall 114 of the container body 101, such that a bottom end 502 of the heat-conducting component 500 is in contact with the refrigeration surface 131. In the present embodiment, the heat-conducting component 500 and the first bottom wall 114 are sealingly connected to each other.

Exemplarily, the container body 101 includes a mounting hole 114a defined in the first bottom wall 114. The mounting hole 114a is communicated with the receiving cavity 101a. It is noted that when the container body 101 and the mounting housing 150 are connected to each other, the mounting hole 114a exposes at least a portion of the refrigeration surface 131 of the refrigeration assembly 130.

The bottom end 502 of the heat-conducting component 500 passes through the mounting hole 114a, or the bottom end 502 of the heat-conducting component 500 is mounted in the mounting hole 114a and is in contact with the refrigeration surface 131. It should be understood that the mounting hole 114a is adapted to a shape and a size of the heat-conducting component 500, facilitating the sealed connection between the first bottom wall 114 and the heat-conducting component 500.

It should be understood that the sealed connection between the heat-conducting component 500 and the first bottom wall 114 prevents liquid leakage from the mounting hole 114a.

Exemplarily, the sealed connection between the heat-conducting component 500 and the first bottom wall 114 includes arranging a seal ring 170a connected between the heat-conducting component 500 and the first bottom wall 114. The sealed connection between the heat-conducting component 500 and the first bottom wall 114 is not limited to arranging the seal ring 170a. One of the heat-conducting component 500 and the first bottom wall 114 defines a sealing slot 171. The seal ring 170a is received in the sealing slot 171. The other one of the heat-conducting component 500 and the first bottom wall 114 compresses the seal ring 170a. In this way, the sealed connection between the heat-conducting component 500 and the first bottom wall 114 is achieved.

In order to define the sealing slot 171, the sealing slot 171 is defined in the first bottom wall 114. Exemplarily, the container body 101 further includes a reinforcing structure 1141 arranged on the first bottom wall 114. The reinforcing structure 1141 is disposed on a side of the first bottom wall 114 away from the refrigeration assembly 130. The reinforcing structure 1141 surrounds the mounting hole 114a. The reinforcing structure 1141 and the first bottom wall 114 cooperatively define the sealing slot 171, and the reinforcing structure 1141 surrounds the seal ring 170a.

It should be noted that, a wall of the container is thin. When the slot is defined directly in the wall of the container, structural stability of the container may be reduced. In the present disclosure, the sealing slot 171 is defined by the first bottom wall 114 and the reinforcing structure 1141 arranged on the first bottom wall 114. In this way, structural strength of the first bottom wall 114 is ensured, and sealing performance between the first bottom wall 114 and the heat-conducting component 500 is improved.

Exemplarily, the seal ring 170a has certain deformation performance. When the seal ring 170a is compressed by an external force such as by the heat-conducting component 500, the seal ring 170a is deformed to a small extent, sealing performance at the connection between the heat-conducting component 500 and the first bottom wall 114 is further improved.

It should be noted that the sealed connection between the first bottom wall 114 and the heat-conducting component 500 is not limited to arranging the seal ring 170a between the first bottom wall 114 and the heat-conducting component 500. In other embodiments, the first bottom wall 114 and the heat-conducting component 500 are glued to each other.

Exemplarily, the bottom end 502 of the heat-conducting component 500 is aligned with an outer surface of the first bottom wall 114.

Exemplarily, the bottom end 502 of the heat-conducting component 500 is attached to the refrigeration surface 131.

Exemplarily, a diameter of the heat-conducting component 500 is substantially equal to a diameter of the refrigeration surface 131, and the bottom end 502 of the heat-conducting component 500 and the refrigeration surface 131 are substantially perfectly attached to each other.

A portion of the heat-conducting component 500 received in the receiving cavity 101a is spaced from the first side wall 112 of the container body 101.

Exemplarily, the mounting housing 150 further includes a second bottom wall 154 and a second side wall 153. The second bottom wall 154 and the second side wall 153 are connected to each other. The second side wall 153 surrounds a circumference of the second bottom wall 154. The second bottom wall 153 defines one or more heat dissipation holes.

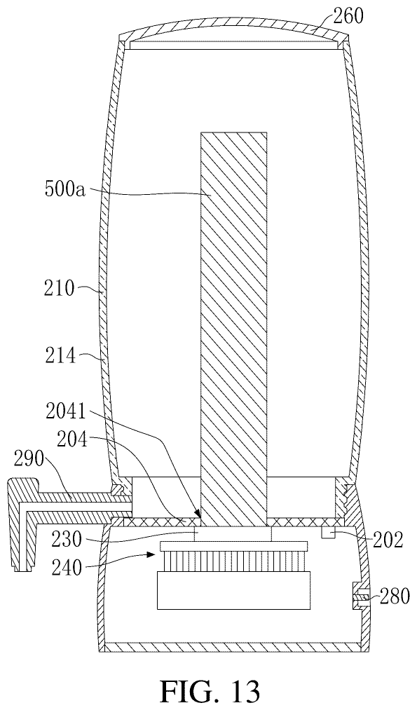

As shown in FIG. 13, the heat-conducting component 500a of the refrigerating container 200 passes through at least a limiting platform 204 to be in contact with the refrigeration surface of the refrigeration assembly 230, and the the heat-conducting component 500a is at least sealingly connected to the limiting platform 204.

Exemplarily, the limiting platform 204 defines a refrigeration hole 2041. The refrigeration surface of the refrigeration assembly 130 is at least partially exposed through the refrigeration hole 2041. The bottom end of the heat-conducting component 500a passes through the container body 210 and the refrigeration hole 2041 of the limiting platform 204 to be in contact with the refrigeration surface of the refrigeration assembly 230. The heat-conducting surface of the refrigeration assembly 230 is in contact with the heat dissipation assembly 240. In this way, the heat-conducting component 500a can conduct heat from the liquid contained in the container body 210 to the refrigeration assembly 230, and the heat dissipation assembly 240 dissipates the heat from the refrigeration assembly 230 to the outside of the container.

A shape of the heat-conducting component 500a can be referred to the heat-conducting component 500 in the above embodiment and will not be repeated herein.

In order to enable the heat-conducting component 500a to pass through the container body 210, a bottom of the container body 210 defines an opening. The opening at the bottom of the container body 210 is opposite to the opening at the top of the container body 210. The heat-conducting component 500a may be inserted through the opening at the bottom of the container body 210 into the refrigeration hole 2041. In other embodiments, the container body 210 may have a side wall 214 and a bottom wall connected to the side wall 214. The bottom wall defines a mounting hole. The heat-conducting component 500a may be inserted, through the mounting hole of the container body 210, into the refrigeration hole 2041. The side wall 214 may be referred to the first side wall 112 in the above embodiment and will not be repeated herein. The bottom wall of the container body 210 and the mounting hole may be referenced to the first bottom wall 114 and the mounting hole 114a in the above embodiment and will not be repeated herein. The opening at the top of the container body 210 may be referred to the opening 101b in the above embodiment and will not be repeated herein.

Exemplarily, the heat-conducting component 500a is sealingly connected to only the limiting platform 204. After the heat-conducting component 500a and the limiting platform 204 are sealingly connected to each other, the limiting platform 204 may be mounted on the mounting housing 150a. In other embodiments, after the heat-conducting component 500a and the limiting platform 204 are sealingly connected to each other, the limiting platform 204 may be mounted on the bottom of the container body 210. The sealed connection between the heat-conducting component 500a and the limiting platform 204 may be referred to the above embodiments and will not be repeated herein.

In other embodiments, the heat-conducting component 500a is sealingly connected to both the limiting platform 204 and the container body 210. It should be noted that the sealed connection between the heat-conducting component 500a and the container body 210 may be referred to the above embodiment and will not be repeated herein. It should be understood that in the case that the heat-conducting component 500a is sealingly connected to both the limiting platform 204 and the container body 210, the limiting platform 204 is attached to the bottom wall of the container body 210.

Exemplarily, the limiting platform 204 is made of a thermally non-conductive material, such as plastic. In other embodiments, the heat-conducting component 500a and the limiting platform 204 are configured as a one-piece and integral structure.

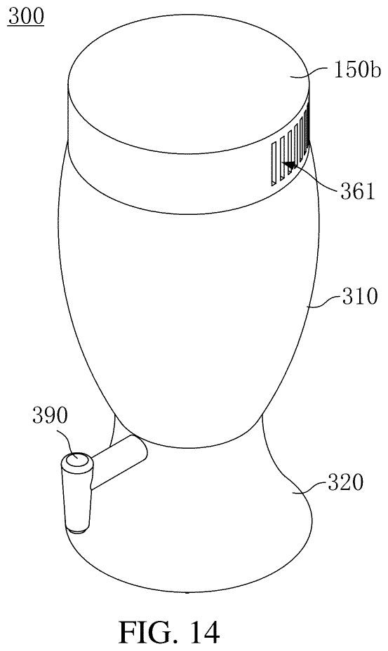

As shown in FIGS. 14 to 16, the refrigeration assembly 330 and the heat dissipation assembly 340 of the refrigerating container 300 are mounted in the mounting housing 150b. The mounting housing 150b is located at the top of the refrigerating container 300. A top end 501b of the heat-conducting component 500b of the refrigerated liquid container 300 is in contact with, such as attached to, the refrigeration surface 331 of the refrigeration assembly 330 mounted in the mounting housing 150b.

The heat-conducting component 500b is connected to the mounting housing 150b. Exemplarily, the mounting housing 150b includes a first bottom wall 362 and a first side wall 364 connected to the first bottom wall 362. The first side wall 364 is connected to a periphery of the first bottom wall 362. The heat-conducting component 500b is connected to the first bottom wall 362. Exemplarily, the mounting housing 150b further includes a mounting hole 365 defined in the first bottom wall 362, the refrigeration surface 331 is at least partially exposed from the mounting hole 365, and the top end 501b of the heat-conducting component 500b is mounted in the mounting hole 365 and is in contact with the refrigeration surface 331.

At least a portion of the heat-conducting component 500b is arranged inside the receiving cavity 311 of the container body 310, and a bottom end 502b of the heat-conducting component 500b is arranged inside the receiving cavity 311. For example, the bottom end 502b of the heat-conducting component 500b is located near the bottom of the container body 310. Exemplarily, the container body 310 includes a second bottom wall 312 and a second side wall 314 connected to the second bottom wall 312. The second side wall 314 is connected to a periphery of the second bottom wall 312. The bottom end 352 of the heat-conducting component 500b is located near the second bottom wall 312.

The heat dissipation assembly 340 is in contact with the heat conducting surface 332 of the refrigeration assembly 330, such that the refrigeration assembly 330 can conduct the heat of the liquid contained in the receiving cavity 311 through the heat-conducting component 500b to the heat dissipation assembly 340, and the heat dissipation assembly 340 dissipates the heat from the refrigeration assembly 330 to the outside of the container. For example, the refrigeration assembly 330, when being supplied with power, conducts heat of the liquid in the receiving cavity 311 through the heat conducting component 500b to the heat dissipation assembly 340; and the heat dissipation assembly 340, when being supplied with power, dissipates the heat from the refrigeration assembly 330 to the outside of the container.

Exemplarily, the mounting housing 150b defines a plurality of heat dissipation holes 361. The heat dissipation assembly 340 dissipates heat from the refrigeration assembly 330 through the plurality of heat dissipation holes 361 to the outside of the container, such as out of the mounting housing 150b. The plurality of heat dissipation holes 361 are spaced apart from each other and are defined in the first side wall 364. The plurality of heat dissipation holes 361 are located surrounding the heat dissipation assembly 340.

In other embodiments, the mounting housing 150b further includes a top wall 368, the top wall 368 is connected to the first side wall 364. The top wall 368 and the first bottom wall 362 are respectively disposed on an upper side and a lower side of the first side wall 364, such that the top wall 368, the first bottom wall 362, and the first side wall 364 cooperatively form a cavity for receiving the refrigeration assembly 330 and the heat dissipation assembly 340. Exemplarily, the top wall 368 defines one or more heat dissipation holes.

The container body 310 has an opening 315. When the mounting housing 150b is detachably mounted on the top of the container body 310 and is mounted on the container body 310, the mounting housing 150b covers the opening 315. The mounting hole 365 is communicated with the opening 315, facilitating a portion of the heat-conducting component 500b to be received within the receiving cavity 311 after the heat-conducting component 500b is connected to the first bottom wall 362.

Exemplarily, the heat-conducting component 500b and the first bottom wall 362 are sealingly connected to each other. For example, a seal ring 370 is connected between the heat-conducting component 500b and the first bottom wall 362. It should be understood that the sealed connection between the heat-conducting component 500b and the first bottom wall 362 is not limited to arranging the seal ring 370. One of the heat-conducting component 500b and the first bottom wall 362 defines a sealing slot 3661, and the seal ring 370 is received in the sealing slot 3661. The other one of the heat-conducting component 500b and the first bottom wall 362 compresses the seal ring 370. In this way, the sealed connection between the heat-conducting component 500b and the first bottom wall 362 is achieved, preventing the liquid from entering the mounting housing 150b from the connection position between the heat-conducting component 500b and the first bottom wall 362, and protecting components arranged in the mounting housing 150b, such as the heat dissipation assembly 340 and the refrigeration assembly 330.

Exemplarily, the mounting housing 150b further includes a reinforcing structure 366 arranged on the first bottom wall 362. The reinforcing structure 366 is disposed on a side of the first bottom wall 362 away from the refrigeration assembly 330. The reinforcing structure 366 surrounds the mounting hole 365. The reinforcing structure 366 and the first bottom wall 362 cooperatively define the sealing slot 3661, and the seal ring 370 is received in the sealing slot 3661. The reinforcing structure 366 surrounds the seal ring 370.

Exemplarily, the top end 351 of the heat-conducting component 500b aligns with an inner surface of the first bottom wall 362.

Exemplarily, the top end 351 of the heat-conducting component 500b is attached to the refrigeration surface 331.

Exemplarily, a diameter of the heat-conducting component 500b is substantially equal to a diameter of the refrigeration surface 331, and the top end 351 of the heat-conducting component 500b and the refrigeration surface 331 are substantially perfectly attached to each other.

The portion of the heat-conducting component 500b received in the receiving cavity 311 is spaced apart from the first side wall 314 of the container body 310.

Exemplarily, the heat-conducting component 500b may be a solid structure. For example, the heat-conducting component 500b may be a cylindrical structure. In other embodiments, the heat-conducting component 500b may be a circular table structure, a conical structure. It should be understood that the heat-conducting component 500b may be other columnar structures, and the present disclosure does not limit the shape of the heat-conducting component 500b.

In other embodiments, the heat-conducting component 500b is not limited to the solid structure. For example, in order to save material, the heat-conducting component 500b has a cavity therein, and it should be noted that in order to prevent liquid contained in the receiving cavity 311 from entering the cavity in the heat-conducting component 500b, the cavity of the heat-conducting component 500b is sealed.

Exemplarily, when the mounting housing 150b is mounted on the container body 310, the second side wall 314 carries the first side wall 364, or the second side wall 314 carries the first side wall 364 and the first bottom wall 362, and an outer surface of the second side wall 314 aligns with an outer surface of the first side wall 364.

Exemplarily, the mounting housing 150b further includes a limiting portion 363, the limiting portion 363 is connected to the outer surface of the first bottom wall 362. The limiting portion 363 protrudes from the outer surface of the first bottom wall 362, and the limiting portion 363 is disposed near the first side wall 364. When the mounting housing 150b is mounted to the container body 310, the limiting portion 363 is mounted in the receiving cavity 311 from the opening 315, and the limiting portion 363 is located near the second side wall 314.

Exemplarily, a thickness of the limiting portion 363 gradually increases from an end of the limiting portion 363 away from the first bottom wall 364 to the other end thereof, and the limiting portion 363 can increase mounting stability between the mounting housing 150b and the container body 310.

Exemplarily, the base 320 of the refrigerating container 300 carries the container body 310, and the base 320 is connected to the container body 310. Exemplarily, the container body 310 further includes a first connection portion 316, the first connecting portion 316 connects the second bottom wall 312 with the second side wall 314. The base 320 includes a base body 321 and a second connection portion 322 connected to the base body 321. The first connection portion 316 is connected to, such as via threading, the second connection portion 322.

Exemplarily, the first connection portion 316 and the second side wall 314 are staggered to each other, such that the first connection portion 316 and the second side wall 314 cooperatively form a step 318. It is noted that a space enclosed by the first connection portion 316 is smaller than a space enclosed by the second side wall 314. In an example, a diameter of the first connection portion 316 is smaller than a diameter of the first side wall 314.

Exemplarily, the second connection portion 322 surrounds the first connection portion 316, and the second connection portion 322 abuts against the second side wall 314. An outer surface of the second connection portion 322 is smoothly transmitted to an outer surface of the second side wall 314, for example, the outer surface of the second connection portion 322 is aligned to the outer surface of the second side wall 314.

The detection member 302, the power connector 380, and the outlet control head 390 of the refrigerating container 300 may be referred to the above embodiment shown in FIGS. 1 to 3, and will not be repeated herein.

Obviously, the above description provides only some of, not all of, the embodiments of the present disclosure. The accompanying drawings provide preferred embodiments of the present disclosure but do not limit the scope of the present disclosure. The present disclosure may be achieved in various forms. Conversely, these embodiments are provided for the purpose of providing a more thorough and comprehensive understanding of the present disclosure. Although the present disclosure has been described in detail with reference to the foregoing embodiments, any ordinary skilled person in the art may modify the technical solutions in the foregoing specific embodiments or may make equivalent substitutions for some technical features therein. Any equivalent structure made based on the specification and the accompanying drawings of the present disclosure, applied directly or indirectly in other related technical fields, shall all be equivalently within the scope of the present disclosure.

What is claimed is:

1. A refrigerating container, comprising:
a container body, having a receiving cavity for receiving liquid, wherein at least a portion of the container body is thermally conductive;
a refrigeration assembly, having a refrigeration surface and a heat-conducting surface opposite to the refrigeration surface; wherein the refrigeration surface is in contact with the container body to cool the container body to cool the liquid received in the container body; and
a heat dissipation assembly, being in contact with the heat conducting surface to dissipate heat from the refrigeration assembly to an outside of the container body.

2. The refrigerating container according to claim 1, wherein the container body has an end wall, the refrigeration surface is in contact with a surface of the end wall away from the receiving cavity.

3. The refrigerating container according to claim 2, further comprising a heat-conducting component, wherein the heat-conducting component is received in the receiving cavity and is connected to the end wall.

4. The refrigerating container according to claim 3, wherein an end of the heat-conducting component passes through the end wall to be in contact with the refrigeration assembly.

5. The refrigerating container according to claim 4, wherein the end of the heat-conducting component is sealingly connected to the end wall.

6. The refrigerating container according to claim 5, wherein the end wall defines a through hole, an end of the heat-conducting component is passes through the through hole; a reinforcing structure is protruding from a surface of the end wall facing the receiving cavity, and the reinforcing structure surrounds the through hole and is spaced apart from the end of the heat-conducting component.

7. The refrigerating container according to claim 6, wherein a sealing member is disposed between the reinforcing structure and the end of the heat-conducting component.

8. The refrigerating container according to claim 2, wherein the heat dissipation assembly comprises a heat dissipation sheet and a fan, the heat dissipation fan is attached to the heat conducting surface of the refrigeration assembly, and the fan is disposed on a side of the heat dissipation sheet away from the refrigeration assembly.

9. The refrigerating container according to claim 8, wherein the heat dissipation sheet comprises a first heat dissipation sheet and a plurality of second heat dissipation sheets; the first heat dissipation sheet is attached to the heat conducting surface, the plurality of second heat dissipation sheets are disposed on a side of the first heat dissipation sheet away from the heat conducting surface; the plurality of heat dissipation sheets are spaced apart from each other.

10. The refrigerating container according to claim 2, further comprising a mounting housing, wherein the refrigeration assembly and the heat dissipation assembly are arranged inside the mounting housing, the container body has a body side wall connected to the end wall; the mounting housing and the body side wall are sealingly connected to each other.

11. The refrigerating container according to claim 10, wherein the mounting housing is disposed above or below the container body.

12. The refrigerating container according to claim 1, further comprising a detection member, wherein the detection member is configured to detect information of the liquid in the receiving cavity, and the information comprises: a temperature of the liquid and/or an amount of the liquid.

13. The refrigerating container according to claim 12, wherein the detection member is configured to, when detecting that the amount of the liquid is reduced to reach a predetermined amount, send a control signal to control the refrigeration assembly and the heat dissipation assembly to stop operating or to reduce an operating power thereof.

14. The refrigerating container according to claim 12, wherein the detection member is configured to, when the temperature of the liquid is detected to reach a predetermined temperature, send a control signal to control the refrigeration assembly and the heat dissipation assembly to stop operating or to reduce an operating power thereof.

15. The refrigerating container according to claim 12, wherein the detection member comprises one or more sensors.

16. The refrigerating container according to claim 1, wherein the container body comprises a first container body and a second container body, the first container body is sealingly connected to the second container body to form the container body.

17. The refrigerating container according to claim 16, wherein the first container body has a first receiving cavity, and the second container body has a second receiving cavity, the first receiving cavity and the second receiving cavity are communicated with each other.

18. The refrigerating container according to claim 1, further comprising an outlet control head, fluidly connected to the receiving cavity to control a flow of the liquid out of the receiving cavity.

19. The refrigerating container according to claim 18, wherein the outlet control head and the refrigeration assembly are respectively located at two opposite ends of the container body or located at a same end of the container body.

20. The refrigerating container according to claim 18, further comprising a transparent member, embedded in a side wall of the container body, wherein the transparent member is configured to enable a user to view the liquid in the receiving cavity from the outside of the refrigerating container, the transparent member is elongated and extending in a height direction of the container body.
